(19) United States
(12) Patent Application Publication
(10) Pub. No.: US 2025/0182033 A1
(43) Pub. Date: Jun. 5, 2025

(54) SYSTEMS AND METHODS FOR GENERATING PRESENTATION MEDIA

(71) Applicant: Capital One Services, LLC, McLean, VA (US)

(72) Inventors: Lea CODY, Washington, DC (US); Alexander PEREPECHKO, Bellevue, WA (US); Anita ERADLA, Ashburn, VA (US); Cayli CHOE, Westmont, IL (US)

(73) Assignee: Capital One Services, LLC, McLean, VA (US)

(21) Appl. No.: 18/529,042

(22) Filed: Dec. 5, 2023

(51) Int. Cl. G06Q 10/067; G06N 20/00

(52) U.S. Cl. CPC G06Q 10/067; G06N 20/00

(57) ABSTRACT

A computer-implemented method may include causing display of a user interface to a user, the user interface prompting the user to enter a user instruction, receiving the user instruction, wherein the user instruction may include one or more parameters for desired media, retrieving, using a machine learning model, based on the user instruction, a plurality of data sets from a plurality of data sources, wherein the machine learning model may be trained to associate data stored in the plurality of data sources with parameters for desired media, generating, using the machine learning model, an intermediate text sequence, wherein the intermediate text sequence may be representative of the plurality of data sets, and generating, based on the intermediate text sequence, a presentation media output, wherein the presentation media output may be representative of the one or more parameters for desired media.

### TECHNICAL FIELD

Various embodiments of the present disclosure relate generally to systems and methods for generating presentation media.

### BACKGROUND

Onboarding of new personnel may be a frequent occurrence within large organizations. During onboarding, new personnel may be presented with large amounts of information including organizational hierarchy, organization charts, product development information, project status information, workflow information, and the like. This information may be derived from dynamic data sources that are modified regularly during the ordinary course of operations of the organization. To the extent possible, such information may be provided to the new personnel in the form of presentation media during onboarding. In growing organizations, onboarding could occur quarterly, monthly, or even more frequently, requiring frequent generation of presentation media.

Given the complexity of modern large organizations, it may be impossible, let alone extremely labor intensive, to retrieve and compile all relevant information for onboarding in a manner that ensures the information is up to date. Compilation of relevant information may, for example, require knowledge of the new personnel's role that is not feasible for any individual to acquire. Additionally, updates to underlying data while presentation media materials are prepared for new personnel may render the data in the materials outdated before they are even provided to the new personnel.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for generating presentation media are described.

In one example, a computer-implemented method for generating presentation media may include: causing display, by one or more processors, of a user interface to a user, the user interface prompting the user to enter a user instruction; receiving, by the one or more processors via the user interface, the user instruction, wherein the user instruction includes one or more parameters for desired media; retrieving, by the one or more processors using a machine learning model, based on the user instruction, a plurality of data sets from a plurality of data sources, wherein the machine learning model may be trained to associate data stored in the plurality of data sources with parameters for desired media; generating, by the one or more processors using the machine learning model, an intermediate text sequence, wherein the intermediate text sequence may be representative of the plurality of data sets; and generating, by the one or more processors based on the intermediate text sequence, a presentation media output, wherein the presentation media output may be representative of the one or more parameters for desired media.

In another example, a non-transitory computer-readable medium may store instructions that, when executed by one or more processors, cause the one or more processors to perform operations including: causing display, by the one or more processors, of a user interface to a user, the user interface prompting the user to enter a user instruction; receiving, by the one or more processors via the user interface, the user instruction, wherein the user instruction may include one or more parameters for desired media; retrieving, by the one or more processors using a machine learning model, based on the user instruction, a plurality of data sets from a plurality of data sources, wherein the machine learning model may be trained to associate data stored in the plurality of data sources with parameters for desired media; generating, by the one or more processors using the machine learning model, an intermediate text sequence, wherein the intermediate text sequence may be representative of the plurality of data sets; and generating, by the one or more processors based on the intermediate text sequence, a presentation media output, wherein the presentation media output may be representative of the one or more parameters for desired media.

In a further example, a system may include: one or more memories storing instructions and a machine learning model trained to associate data stored in a plurality of data sources with parameters for desired media, wherein the machine learning model is trained at least in part using manually tagged first training data sets from the plurality of data sources; and one or more processors operatively connected to the one or more memories. The one or more processors may be configured to execute the instructions to: cause display of a user interface to a user, the user interface prompting the user to enter a user instruction; receive, via the user interface, the user instruction, wherein the user instruction may include one or more parameters for desired media; retrieve, using the machine learning model, based on the user instruction, a plurality of data sets from the plurality of data sources, the plurality of data sets including a media template; generate, using the machine learning model, an intermediate text sequence, wherein the intermediate text sequence may be representative of the plurality of data sets; and generate, based on the intermediate text sequence, a set of presentation slides, wherein set of presentation slides may be representative of the one or more parameters for desired media and corresponds to the media template.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts an exemplary functional block diagram of a presentation media generation system and data sources, according to one or more embodiments.

FIG. 3 depicts a flowchart of an exemplary method of generating a presentation media output, according to one or more embodiments.

FIG. 4 depicts a flowchart of an exemplary method of training a machine learning model, according to one or more embodiments.

FIG. 5 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first user device could be termed a second user device, and, similarly, a second user device could be termed a first user device, without departing from the scope of the various described embodiments. The first user device and the second user device are both user devices, but they are not the same user device.

In general, the present disclosure is directed to systems and methods for generating presentation media. The methods and systems according to the present disclosure offer significant technical benefits which will become apparent. For example, aspects of the present disclosure may significantly improve and simplify processes for preparing presentation media derived from multiple dynamic data sources. Aspects of the present disclosure may also provide an ability to keep data included in the presentation media and derived from the dynamic data sources updated and current despite rapid changes to the underlying data.

More specifically, the present disclosure may be applicable for large organizations in which onboarding of new personnel is a frequent occurrence. As part of the onboarding process, new personnel may be presented with large amounts of information from multiple dynamic data sources. For example, new personnel may be presented with information about existing personnel, including organizational hierarchy, organization charts, and the like. New personnel may also be provided with product development information, project status information, workflow information, scheduling and meeting information, performance metrics, and/or any other information relevant to the new personnel. This information may be provided for the purpose of orienting the new personnel to the organization and/or the new personnel's particular responsibilities. The information provided in the presentation media may indeed be unique to the personnel and include information particularly relevant to the new personnel and/or their role.

Such information may be retrieved, compiled, and provided to the new personnel in the form of presentation media during onboarding. As used herein, the term “presentation media” generally refers to presentation slides, such as PowerPoint™ slides or PDFs. It should be understood, however, that the term presentation media is not so limited and may include other types of electronic documents and media, such as text documents, Word™ documents, business and/or marketing collateral, digital video, digital audio, other types of digital media, and/or any other type of presentation that may be useful for distributing information to individuals within an organization.

In large organizations, the relevant information may have to be retrieved from multiple data sources. Retrieval may be extremely labor intensive and time consuming, and may further require specialized organizational knowledge. For example, for new personnel having a particular role within an organization or joining a particular team or division of an organization, relevant onboarding information may include a specific set of data from specific data sources. New personnel having a different role or joining a different particular team or segment of the organization may receive information including different data from the same or different data sources. Additionally, given the complexity of certain organizations and the volumes of data regularly generated by them, it may be impossible for any individuals to know all the organizational data that may be relevant to any given personnel. Moreover, given that data in a large organization may be updated frequently, if not constantly, information retrieved for presentation media may be outdated before it can even be compiled and provided to the new personnel.

Accordingly, a need exists to address the foregoing challenges. Particularly, a need exists to improve generation of presentation media incorporating data from dynamic data sources. Embodiments of the present disclosure offer technical solutions to address the foregoing needs, as well as other needs.

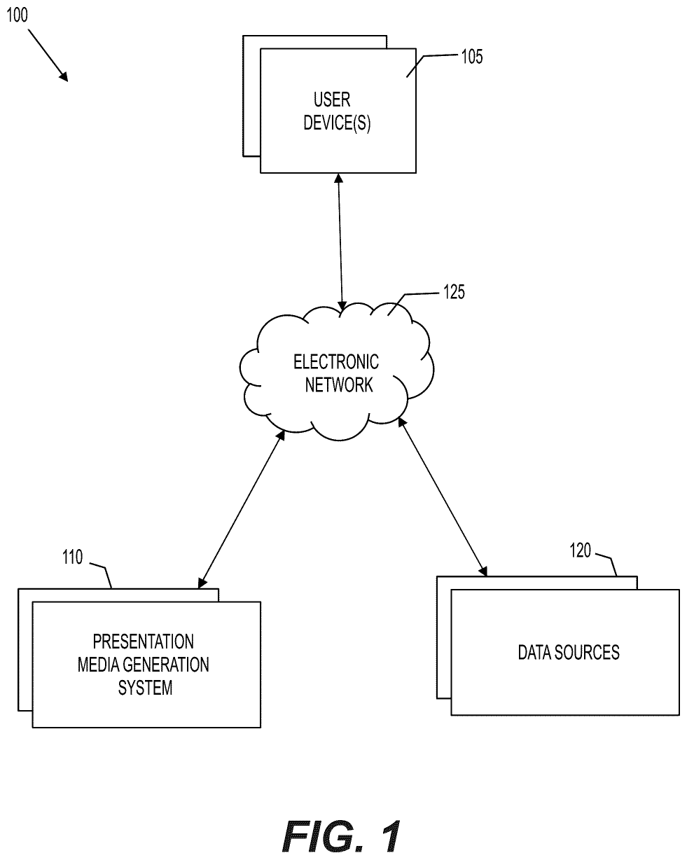

FIG. 1 depicts an exemplary computing environment 100 that may be utilized with techniques presented herein. One or more user device(s) 105, a presentation media generation system 110, and data sources 120 may communicate across an electronic network 125. The user device 105 may be associated with, and used by, a user. For example, the user may be an individual tasked with ensuring that presentation media is created and/or provided to new personnel during onboarding into an organization. In some instances, the user may be new personnel for the organization and may access the presentation media via user device 105. The systems and devices of the computing environment 100 may communicate in any arrangement. As will be discussed herein, systems and/or devices of the computing environment 100 may communicate in order to generate presentation media.

The user device 105 may be a computer system such as, for example, a desktop computer, a mobile device, etc. In an exemplary embodiment, the user device 105 may be a cellphone, a tablet, or the like. In some embodiments, the user device 105 may include one or more electronic application(s), e.g., a program, plugin, browser extension, etc., installed on a memory of the user device 105. In some embodiments, the electronic application(s) may be associated with one or more of the other components in the computing environment 100. For example, the electronic application(s) may include a browser, or the like, configured to allow access to presentation media generation system 110 and/or data stored within data sources 120.

In some embodiments, user device 105 may be configured for use with systems of an organization or enterprise. For example, user device 105 may be configured to provide access to various business and/or productivity software and services. Such software and services may include Microsoft™ Office™ products, Google™ products, project tracking software, data intelligence software, customer relationship management software, scheduling software, human resources software, and the like. User device 105 may be configured to access one or more data sources 120 containing data corresponding to each piece of software. For example, user device 105 may be configured to query a remote data source 120 to access data relevant to any particular software application. Such a configuration may allow multiple user devices 105 access to the same information and thereby enable multiple users within the organization to work collaboratively using the data.

Presentation media generation system 110 may be a computer system configured to generate presentation media to be used, for example, for onboarding personnel to the organization. Presentation media generation system 110 may generate presentation media in response to instructions received from a user device 105, for example. The presentation media may then be viewed or otherwise consumed via the same user device 105 and/or a different user device 105 operated by a different user. Presentation media generation system 110 may comprise one or more server devices and the one or more server devices may be located in one or more physical locations. For example, presentation media generation system 110 may exist within a cloud infrastructure supported by a plurality of server devices distributed across multiple geographical locations.

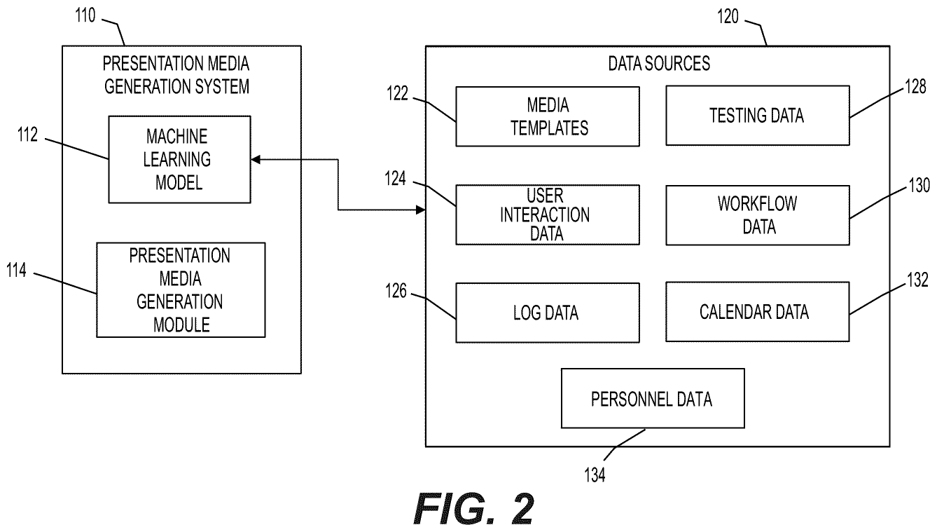

As shown in FIG. 2, presentation media generation system 110 may include a machine learning model 112 and a presentation media generation module 114. In some embodiments, machine learning model 112 may be a large language model (LLM). In some embodiments, machine learning model 112 may be a generative pre-trained transformer (GPT) large language model. Machine learning model 112 may be trained, as will be described in greater detail hereinafter, to retrieve information stored in data sources 120 based on a user instruction received from user device 105. Machine learning model 112 may be further trained to synthesize the information retrieved from data sources 120 into a text sequence, based on the user instruction from user device 105.

Presentation media generation module 114 may be a subsystem of presentation media generation system 110 configured to work with machine learning model 112. In some embodiments, present media generation module 114 may be configured to convert a text sequence generated by machine learning model 112 into presentation media that is more easily digestible by a user. In some embodiments, presentation media generation module 114 may include a machine learning model distinct from machine learning model 112 that may be trained to convert a text sequence generated by machine learning model 112 into presentation media. In some embodiments, presentation media generation module 114 may be a component of machine learning model 112. In some embodiments, presentation media generation module 114 may include software other than a machine learning model that is configured to convert a text sequence generated by machine learning model 112 into presentation media.

In some embodiments, machine learning model 112 and/or presentation media generation module 114 may be generated, trained, and/or stored externally of presentation media generation system 110. For example, machine learning model 112 and presentation media generation module 114 may be accessible to presentation media generation system 110 as a SaaS product, via an API. or otherwise remotely accessible.

Data sources 120 may be a computer system for storing data of an organization, where the data may be accessible by user device 105. Data sources 120 may be configured in any suitable manner. For example, data sources 120 may comprise one or more server devices and the one or more server devices may be located in one or more physical locations. In some embodiments, data sources 120 may exist within a cloud infrastructure supported by a plurality of server devices distributed across multiple geographical locations.

As shown in FIG. 2, data sources 120 may include, for example, media templates 122, user interaction data 124, log data 126, testing data 128, workflow data 130, calendar data 132, and personnel data 134. Each of media templates 122, user interaction data 124, log data 126, testing data 128, workflow data 130, calendar data 132, and personnel data 134 may exist in one or more separate or combined data storage containers. In some embodiments, one or more of the foregoing data sources may be maintained by an external entity such as a software as a service (Saas) product. For example, the organization may outsource various capabilities to SaaS entities that maintain the data. In such instances, the data may be accessible to presentation media generation system 110 via an application programming interface (API).

Media templates 122 may include templates for presentation media generated by presentation media generation system 110. For example, media templates 122 may include templates with organizational branding, predetermined formatting, or the like. Media templates 122 may further include templates with varying tones, ranging from very professional to entertaining. User interaction data 124 may include records of interactions with customer facing applications. For example, the organization may offer a product in the form of a mobile application and user interaction data 124 may include information related to screen time, button presses, session length, feature activations, or any other metric for measuring engagement or interaction with the application. In embodiments, in which the organization offers a web-based product, user interaction data 124 may include similar data corresponding to the web-based product. User interaction data 124 may further include tagging corresponding to user interactions for organizing and/or filtering the information.

Log data 126 may include log information relating to the organization. For example, log data 126 may include application logs, database logs, network logs, configuration logs, task scheduling logs, and computing performance logs. Log data 126 may further include summarizations and/or visualizations of the foregoing raw log data. Testing data 128 may include data relating to any testing relevant to the organization. For example, testing data 128 may include test results measuring adherence to performance metrics by teams and/or individual personnel. Testing data 128 may also include tests for products that are in development and/or products that have been deployed. In some embodiments, testing data 128 may be maintained by a SaaS product, such as Tableau™ or the like. Workflow data 130 may include data relating to workflow within the organization. For example, workflow data 130 may include product development tracking information, task tracking information, and the like. Workflow data 130 may be maintained by SaaS products such as Jira™, Airtable™, or the like.

Calendar data 132 may include scheduling and/or meeting information for the organization and/or personnel within the organization. Calendar data 132 may include Google™ Calendar information, Outlook™ Calendar information, or information from any other suitable calendar software or service. Personnel data 134 may include information about personnel within the organization, including information about individuals, organizational hierarchies, organization charts, and the like. Personnel data 134 may be maintained by a SaaS product, such as PeopleSoft™, for example.

While examples of data sources 120 are provided in FIG. 2, it should be understood that data sources 120 could include other types of data not explicitly shown or described, including any data that may be relevant to the organization and/or personnel of the organization.

In various embodiments, the electronic network 125 may be a wide area network (“WAN”), a local area network (“LAN”), personal area network (“PAN”), or the like. In some embodiments, electronic network 125 may be a secured network. In some embodiments, the secured network may be protected by any of various encryption techniques. In some embodiments, electronic network 125 may include the Internet, and information and data provided between various systems occurs online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). In some embodiments, the electronic network 125 includes or is in communication with a telecommunications network, e.g., a cellular network.

Although depicted as separate components in FIG. 1, it should be understood that a component or portion of a component may, in some embodiments, be integrated with or incorporated into one or more other components. Any suitable arrangement of the various systems and devices of the computing environment 100 may be used.

Hereinafter, methods of using the computer environment 100 are described. In the methods described, various acts are described as performed or executed by one or more components shown in FIG. 1, such as user device 105, presentation media system 110, and/or data sources 120. However, it should be understood that in various embodiments, various components or combinations of components of the computing environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

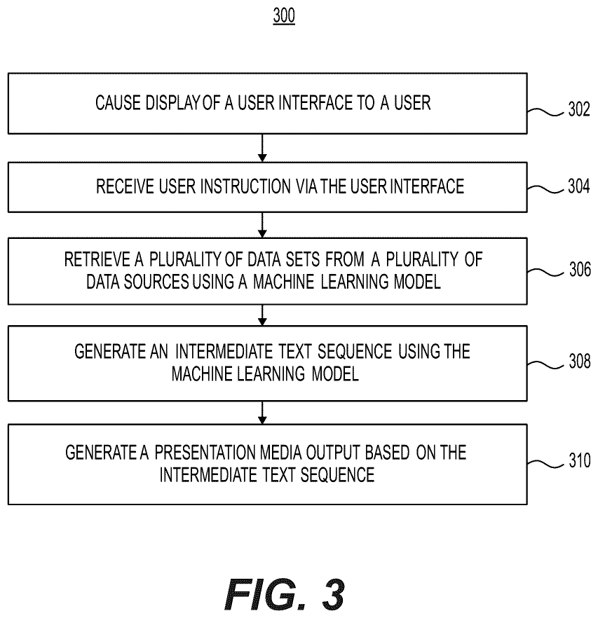

FIG. 3 depicts an exemplary process 300 of generating presentation media, according to one or more embodiments. Process 300 may be performed, for example, to supplement the onboarding of new personnel to an organization. It is to be understood that the process 300 may include fewer than all steps shown in FIG. 3 or may alternatively include additional steps not shown in FIG. 3.

At step 302, presentation media generation system 110 may cause display of a user interface to a user via user device 105. The user may be an individual tasked with ensuring that presentation media are provided to new personnel for onboarding. In some embodiments, the user may navigate to the particular user interface from a general menu of options. In some embodiments, the user interface may include a text prompt into which the user may enter textual instructions. In some embodiments the user interface may include a prompt to provide a voice command. In some embodiments, the user interface may include a series of point-and-click icons and/or drop-down lists. For example, the user interface may include an icon corresponding to creation of presentation media for onboarding and may further include a drop-down list of individuals for whom onboarding is expected, e.g. new hires.

At step 304, presentation media generation system 110 may receive a user instruction submitted via the user interface. For example, where the user interface includes a text prompt, the user may enter a text phrase such as “PREPARE ONBOARDING MATERIALS FOR JOHN SMITH.” In embodiments in which the user interface prompts the user for a voice command, the user instruction may include audio of a verbalized phrase. In embodiments in which the user interface includes point-and-click icons, the user instruction may include selection of an icon corresponding to creation of presentation media for onboarding. The user instruction may further include an indication of one or more individuals. For example, where the new personnel to receive the presentation materials includes an individual named John Smith, the user instruction may include a selection of “JOHN SMITH” from a drop-down list, or the like. In some embodiments, the user instruction may include a more general indication of one or more individuals. For example, the user instruction may include an indication of any new personnel starting on a particular date or within a particular range of dates. As another example, the user instruction may include an indication of a unit, segment, or division of the organization. In essence, the user instructions may provide parameters for desired presentation media to be generated by presentation media generation system 110.

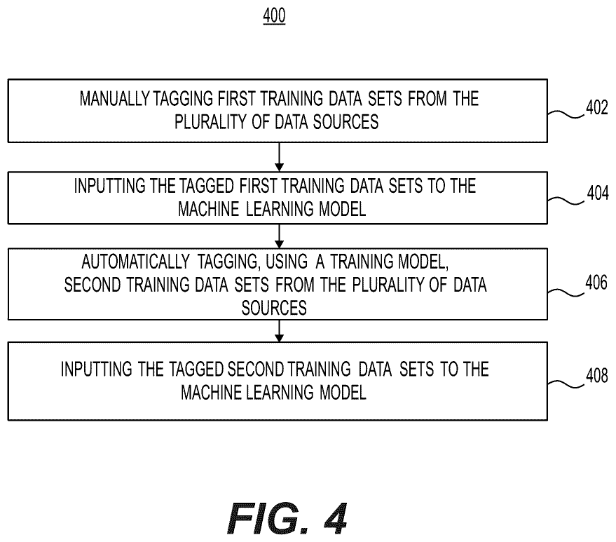

At step 306, presentation media generation system 110 may retrieve a plurality of data sets from data sources 120 using machine learning model 112. As will be described hereinafter in greater detail with reference to FIG. 4, machine learning model 112 may be trained to associate data stored in data sources 120 with parameters for desired media. As stated, the parameters for desired media may be derived from the user instruction received in step 304. Presentation media generation system 110 may retrieve the plurality data sets, using trained machine learning model 112, based on the user instruction received in step 304. By way of example, if the user instruction includes the textual phrase “PREPARE ONBOARDING MATERIALS FOR JOHN SMITH,” machine learning model 112 may retrieve data from data sources 120 that are relevant to the onboarding of John Smith to the organization. For instance, machine learning model 112 may access personnel data 134 to retrieve information about John Smith. Such information may include the role John Smith is expected to have with the organization. Machine learning model 112 may also retrieve information about a unit or division within which John Smith is expected to work. Such information may further include an organizational hierarchy showing individuals to whom John Smith is expected to report and individuals who are expected to report to John Smith.

Machine learning model 112 may access media templates 122 to retrieve a media template relevant to John Smith and/or onboarding. For example, machine learning model 112 may retrieve a media template with organizational branding. The retrieved media template may also include formatting specific to John Smith's role with the organization and/or the unit or division within which John Smith will work. The retrieved media template may further be specific to onboarding, whereas other media templates may be stored within media templates 122 that are applicable to other functions within the organization.

Continuing with the example relating to John Smith, machine learning model 112 may retrieve information from user interaction data 124, log data 126, testing data 128, and/or workflow data 130 based on John Smith's role within the organization. If John Smith is expected to assume a role relating to user engagement with a particular product within the organization, machine learning model 112 may retrieve information relating to user engagement with the product from user interaction data 124. If John Smith is expected to assume a role relating to systems engineering or maintenance, machine learning model 112 may retrieve log information for the organization from log data 126. If John Smith is expected to assume a management role overseeing one or more particular products and/or one or more particular units within the organization, machine learning model 112 may retrieve information relating to testing of relevant products and/or units from testing data 128. If John Smith is expected to assume a project management role, machine learning model 112 may retrieve information relating to project development and/or distribution of assignments from workflow data 130. It should be understood that the foregoing examples have been provided for context only and that there may be instances in which other relevant information is retrieved from any or all of the foregoing data sources.

Additionally, machine learning model 112 may retrieve calendar and/or scheduling information from calendar data 132. Such information may include training meetings scheduled for John Smith. In some embodiments, such information may include recurring meetings that John Smith will be expected to attend as part of his role with the organization. In some embodiments, such information may include schedules of other individuals with which John Smith is expected to work.

As discussed herein previously, some or all of data sources 120 may be maintained by external entities such as a SaaS providing entity. In some embodiments, retrieval of the data from data sources 120 by machine learning model 112 may require calling of one or more APIs. In some embodiments, tokens and/or login credentials may be required to authenticate the user with the APIs and/or retrieve data from the data sources. In some embodiments, a particular user interacting with machine learning model 112 may be authenticated via an API for access to only a subset of data maintained by a data source. Use of tokens and/or login information may allow the system to limit access of the underlying data to certain individuals.

At step 308, machine learning model 112 may generate an intermediate text sequence representative of the data sets retrieved in step 306. For example, machine learning model 112 may synthesize the information retrieved from data sources 120 in step 306 into a text sequence that summarizes the retrieved information. In some embodiments, the text sequence may be generated specifically for transformation into presentation media by presentation media generation module 114.

At step 310, presentation media generation module 114 may generate a presentation media output based on the intermediate text sequence. The presentation media output may be representative of the parameters for desired media included in the user instruction. For example, where the user instruction includes the textual phrase “PREPARE ONBOARDING MATERIALS FOR JOHN SMITH,” the presentation media output may include an onboarding slide deck for John Smith including information determined to be relevant to John Smith by machine learning model 112. Presentation media generation module 114 may be configured to transform the intermediate text sequence provided by machine learning model 112 into the presentation media output. For example, presentation media generation module 114 may convert the intermediate text sequence into a series of presentation slides including graphics and visualizations of the text sequence and the data represented therein. In some embodiments, the presentation media output may include a representation of the organizational structure within which John Smith will be assigned. Once generated, the presentation media output may be in condition to be provided to John Smith with information relevant to his onboarding.

Additionally, presentation media generation module 114 may be configured to generate calendar meetings, appointments, and/or events based on the intermediate text sequence. In the context of onboarding John Smith, it may be customary within the organization during onboarding to have orientation meetings with individuals within the organization. Presentation media generation module 114 may be configured to schedule such meetings via the presentation media output or may be configured to schedule such meetings directly by interacting with John Smith's electronic calendar application.

Process 300 may therefore allow for generation of detailed and comprehensive presentation media with minimal user input at the front end. Additionally, process 300 may allow for collection and synthesis of information that would otherwise be impossible for one or more individuals. In the example of generating onboarding materials for John Smith, process 300 may allow for retrieval of up-to-date information from multiple dynamic data sources and conversion of that information into digestible presentation media suitable for orienting John Smith to the organization. Moreover, generation of the presentation media may occur with minimal lead time and with minimal human input, thereby obviating the need for large numbers of working hours to prepare the presentation media.

It is to be understood that process 300 need not necessarily be performed in the exact order described herein and the steps described herein may be rearranged in some embodiments. Further, in some embodiments fewer than all steps of process 300 may be performed and in some embodiments additional steps may be performed.

FIG. 4 depicts an exemplary process 400 of training a machine learning model, such as machine learning model 112, that may be used to generate presentation media. It is to be understood that the process 400 may include fewer than all steps shown in FIG. 4 or may alternatively include additional steps not shown in FIG. 4.

At step 402, first training data sets may be selected from data sources 120 and the data may be manually tagged. For example, the first training data sets may include data sets from any or all of media templates 122, user interaction data 124, log data 126, testing data 128, workflow data 130, calendar data 132, and/or personnel data 134. The first training data sets may be manually tagged to be associated with one or more user instructions, portions of user instructions, and/or parameters for desired media that may be contained within user instructions. For example, the first training data sets may be tagged to be associated with one or more individuals within an organization, one or more units or divisions within the organization, one or more types of presentation media, and/or any combination of the foregoing. At step 404, the tagged first training data sets may be input to machine learning model 112.

At step 406, second training data sets from data sources 120 may be tagged automatically. In some embodiments, the automatic tagging may be performed by a training model configured to train machine learning models. In some embodiments, the automatic tagging may be performed by an external SaaS and/or cloud-based service, such as Amazon™ SageMaker™. The training model or service may retrieve the second training data sets from data sources 120 based on the tagged first training data sets, training parameters manually input to the training model or service, or a combination thereof. Similar to step 402, the second training data sets may be tagged to be associated with one or more user instructions, portions of user instructions, and/or parameters for desired media that may be contained within user instructions. At step 408, the tagged second training data sets may be input to machine learning model 112.

In some embodiments, steps 406 and 408 may be performed repeatedly and/or continuously to train machine learning model 112. In some embodiments, the training model or service may be adjusted between iterations of steps 406 and 408 to fine tune machine learning model 112 as desired.

Process 400, as described herein, may result in machine learning model 112 being trained to associate user instructions, such as the examples provided herein previously, including parameters for desired media, with data stored within data sources 120. For example, upon entry of a user instruction such as “PREPARE ONBOARDING MATERIALS FOR JOHN SMITH,” machine learning model 112 may be trained to provide an identification from data sources 120 of John Smith, what role he will have with the organization, when he will begin in his position, and/or any other information relevant to John Smith and stored within data sources 120. Machine learning model 112 may be further trained to retrieve information from data sources 120 that is relevant to the onboarding of John Smith and generate an intermediate text sequence based thereon, as described herein previously. Training of machine learning model 112 may therefore ultimately allow for the generation of presentation media to be provided to John Smith during onboarding or the like where such presentation media includes information directed toward the orientation of John Smith toward the organization and/or his role within the organization.

While process 400 has been described herein with reference to training machine learning model 112, it should be understood that in embodiments in which presentation media generation module 114 is incorporated in machine learning model 112, process 400 may be performed in a similar fashion, thereby resulting in training of both machine learning model 112 and presentation media generation module 114.

The systems and methods described herein previously offer substantial technical advantages. By leveraging machine learning to generate presentation media for applications such as onboarding individuals to an organization, significant human effort may be redirected to other functions within the organization. Additionally, higher qualities of data, greater quantities of data, and more recent data may be retrieved and synthesized into presentation media than could possibly be achieved using human efforts. Moreover, by centralizing the process of presentation media generation to a computer system, an organization's sensitive data may be exposed to fewer individuals, thereby improving security of the sensitive data. Centralization of presentation media generation may also ultimately reduce the computational load and power required by an organization to generate presentation media. For example, in lieu of a team of individuals working across a network of connected devices, a centralized presentation media generation system may reduce the quantity of devices and network connections used in the generation of presentation media.

While the foregoing description discusses generation of presentation media for the purposes of onboarding personnel, it should be understood that the examples discussed herein are provided for context only and the present disclosure is not so limited. Indeed, the methods and systems described herein may be applicable in other contexts in which generation of presentation media containing data from multiple dynamic data sources is desirable.

Further aspects of the disclosure are discussed below. It should be understood that embodiments in this disclosure are exemplary only, and that other embodiments may include various combinations of features from other embodiments, as well as additional or fewer features.

In general, any process discussed in this disclosure that is understood to be computer-implementable or computer-implemented, such as the processes illustrated in FIGS. 3 and 4, may be performed by one or more processors of a computer system. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system may include one or more computing devices. If the one or more processors of the computer system are implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

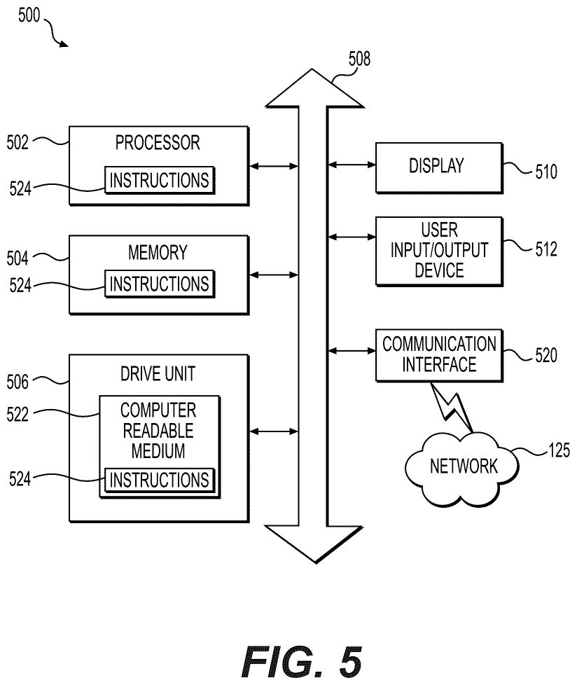

FIG. 5 is a simplified functional block diagram of a computer system 500 that may be configured as a device for executing the processes of FIGS. 3 and 4, according to exemplary embodiments of the present disclosure. FIG. 5 is a simplified functional block diagram of a computer that may be configured to serve as the user device 105, the presentation media generation system 110, and/or the data sources 120, according to exemplary embodiments of the present disclosure. In various embodiments, any of the systems herein may be an assembly of hardware including, for example, a data communication interface 520 for packet data communication. The platform also may include a central processing unit (“CPU”) 502, in the form of one or more processors, for executing program instructions. The platform may include an internal communication bus 508, and a storage unit 506 (such as ROM, HDD, SDD, etc.) that may store data on a computer readable medium 522, although the system 500 may receive programming and data via network communications including via network 125. The system 500 may also have a memory 504 (such as RAM) storing instructions 524 for executing techniques presented herein, although the instructions 524 may be stored temporarily or permanently within other modules of system 500 (e.g., processor 502 and/or computer readable medium 522). The system 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the processes depicted in FIGS. 3 and 4, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for generating presentation media, the method comprising:
causing display, by one or more processors, of a user interface to a user, the user interface prompting the user to enter a user instruction;
receiving, by the one or more processors via the user interface, the user instruction, wherein the user instruction includes one or more parameters for a desired media;
retrieving, by the one or more processors using a machine learning model, based on the user instruction, a plurality of data sets from a plurality of data sources, wherein the machine learning model is trained to associate data stored in the plurality of data sources with parameters for the desired media;
generating, by the one or more processors using the machine learning model, an intermediate text sequence, wherein the intermediate text sequence is representative of the plurality of data sets; and
generating, by the one or more processors based on the intermediate text sequence, a presentation media output, wherein the presentation media output is representative of the one or more parameters for the desired media.

2. The computer-implemented method of claim 1, further comprising:
training the machine learning model, wherein the training includes manually tagging first training data sets from the plurality of data sources and inputting the tagged first training data sets to the machine learning model.

3. The computer-implemented method of claim 2, wherein the training further includes automatically tagging, using a training model, second training data sets from the plurality of data sources and inputting the tagged second training data sets to the machine learning model.

4. The computer-implemented method of claim 1, wherein the machine learning model is a generative pre-trained transformer model.

5. The computer-implemented method of claim 1, wherein the presentation media output includes a set of presentation slides.

6. The computer-implemented method of claim 5, wherein the set of presentation slides are indicative of one or more scheduled events, the method further comprising:
generating, by the one or more processors, one or more calendar entries corresponding to the scheduled events.

7. The computer-implemented method of claim 1, wherein the plurality of data sets includes calendar data, log data, user interaction data, testing data, performance data, or workflow data.

8. The computer-implemented method of claim 1, wherein the user instruction includes an identification of an individual, the data sets retrieved by the machine learning model are associated with the individual, and the presentation media output is customized for the individual.

9. The computer-implemented method of claim 1, further comprising:
authenticating, by the one or more processors, the user to access at least one of the plurality of data sources, wherein the authentication is based on at least a set of login credentials corresponding to the user.

10. The computer-implemented method of claim 9, wherein access to the at least one of the plurality of data sources is limited to a subset of data stored in the at least one of the plurality of data sources.

11. The computer-implemented method of claim 1, wherein the plurality of data sets includes a media template and the presentation media output corresponds to the media template.

12. The computer-implemented method of claim 1, wherein the user instruction includes an identification of an individual, the plurality of data sets includes data indicative of organizational structure for an organization associated with the individual, and the presentation media output includes a representation of the organizational structure.

13. A non-transitory computer-readable medium storing instructions that, when executed by one or more processors, cause the one or more processors to perform operations comprising:
causing display, by the one or more processors, of a user interface to a user, the user interface prompting the user to enter a user instruction;
receiving, by the one or more processors via the user interface, the user instruction, wherein the user instruction includes one or more parameters for a desired media;
retrieving, by the one or more processors using a machine learning model, based on the user instruction, a plurality of data sets from a plurality of data sources, wherein the machine learning model is trained to associate data stored in the plurality of data sources with parameters for the desired media;
generating, by the one or more processors using the machine learning model, an intermediate text sequence, wherein the intermediate text sequence is representative of the plurality of data sets; and
generating, by the one or more processors based on the intermediate text sequence, a presentation media output, wherein the presentation media output is representative of the one or more parameters for the desired media.

14. The non-transitory computer-readable medium of claim 13, wherein the presentation media output includes a set of presentation slides.

15. The non-transitory computer-readable medium of claim 14, wherein the set of presentation slides are indicative of one or more scheduled events, the operations further comprising:
generating, by the one or more processors, one or more calendar entries corresponding to the scheduled events.

16. The non-transitory computer-readable medium of claim 13, wherein the plurality of data sets includes calendar data, log data, user interaction data, testing data, performance data, or workflow data.

17. The non-transitory computer-readable medium of claim 13, wherein the user instruction includes an identification of an individual, the data sets retrieved by the machine learning model are associated with the individual, and the presentation media output is customized for the individual.

18. The non-transitory computer-readable medium of claim 13, wherein the operations further comprise:
authenticating, by the one or more processors, the user to access at least one of the plurality of data sources, wherein the authentication is based on at least a set of login credentials corresponding to the user.

19. The non-transitory computer-readable medium of claim 18, wherein access to the at least one of the plurality of data sources is limited to a subset of data stored in the at least one of the plurality of data sources.

20. A system comprising:
one or more memories storing instructions and a machine learning model trained to associate data stored in a plurality of data sources with parameters for a desired media, wherein the machine learning model is trained at least in part using manually tagged first training data sets from the plurality of data sources; and
one or more processors operatively connected to the one or more memories, the one or more processors configured to execute the instructions to:
cause display of a user interface to a user, the user interface prompting the user to enter a user instruction;
receive, via the user interface, the user instruction, wherein the user instruction includes one or more parameters for the desired media;
retrieve, using the machine learning model, based on the user instruction, a plurality of data sets from the plurality of data sources, the plurality of data sets including a media template;
generate, using the machine learning model, an intermediate text sequence, wherein the intermediate text sequence is representative of the plurality of data sets; and
generate, based on the intermediate text sequence, a set of presentation slides, wherein the set of presentation slides is representative of the one or more parameters for the desired media and corresponds to the media template.
